(19) United States
(12) Patent Application Publication
(10) Pub. No.: US 2013/0305900 A1
(43) Pub. Date: Nov. 21, 2013

(54) KEYBOARD UNIT AND KEYBOARD MUSICAL INSTRUMENT

(71) Applicant: CASIO COMPUTER CO., LTD., Tokyo (JP)

(72) Inventor: Shigeyuki NAGATSUMA, Ome-shi (JP)

(73) Assignee: CASIO COMPUTER CO., LTD., Tokyo (JP)

(21) Appl. No.: 13/894,241

(22) Filed: May 14, 2013

(30) Foreign Application Priority Data
May 18, 2012 (JP) 2012-114581

(51) Int. Cl. G10C 3/12

(52) U.S. Cl. CPC G10C 3/12
USPC 84/423 R

(57) ABSTRACT

In the present invention, a keyboard unit includes a keyboard section placed in a unit case on a bottoms plate, a keyboard lid which has a front lid and a rear lid that are foldable and coupled together, and operably and closably covers the keyboard section, and a lid guide section which guides the keyboard lid so that it opens or closes.

### CROSS-REFERENCE TO RELATED APPLICATION

This application is based upon and claims the benefit of priority from the prior Japanese Patent Application No 2012-114581, filed May 18, 2012, the entire contents of which are incorporated herein by reference.

### BACKGROUND OF THE INVENTION

1. Field of the Invention

The present invention relates to a keyboard unit for use in a keyboard musical instrument such as an electronic piano or an electronic organ and to a keyboard musical instrument including the keyboard unit.

2. Description of the Related Art

A keyboard musical instrument is known which is structured such that a keyboard section provided in a musical instrument case is openably and closably covered by a keyboard lid, as described in Japanese Patent Application Laid-Open (Kokai) Publication No. Heisei 08-314435. In this case, the musical instrument case includes a bottom plate, a front plate, a rear plate, side plates, and a top plate, and has a substantially box shape. The front side of the top plate is open upward. The keyboard lid is structured to be foldable by a front lid and a rear lid being coupled together.

In this keyboard musical instrument, when an accessory component such as a loudspeaker is to be placed in the musical instrument case, the position where the accessory component is to be placed is limited due to opening and closing operations of the keyboard lid. For this reason, the size and shape of the musical instrument case of this keyboard musical instrument differ depending on, for example, whether a loudspeaker, which is an accessory component, is placed on the bottom plate or the lower surface of the top plate. According to the position where the loudspeaker is to he placed, musical instrument cases are required to be manufactured individually. Moreover, in an acoustic space formed near a loudspeaker in the musical instrument case, acoustic influences, such as spatial division due to movement of a lid, are required to be avoided as much as possible. These restrictions disadvantageously make manufacture complex and cumbersome, and increase cost.

### SUMMARY OF THE INVENTION

An object of the present invention is to achieve commonality of basic components constituting a keyboard musical instrument, and to provide a keyboard unit and a keyboard musical instrument capable of improving productivity.

In accordance with one aspect of the present invention, there is provided a keyboard unit comprising: a unit case which has a bottom plate; a keyboard chassis; a keyboard section which has a plurality of keys arranged in parallel to each other; and a lid guide section which guides a keyboard lid having a plurality of lid sections which are foldable and coupled together, wherein the lid guide section guides the keyboard lid such that folding of the keyboard lid is released when the keyboard lid covers upper side of the keyboard section, and guides the keyboard lid by folding the keyboard lid such that at least part of the plurality of lid sections is directed toward a direction of rear portion of the keyboard section and the bottom plate and thereby accommodated in the unit case behind the keyboard section when the keyboard lid exposes the upper side of the keyboard section.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is an enlarged sectional view of a keyboard unit according to an embodiment, in which the present invention has been applied to a keyboard musical instrument;

FIG. 2 is an enlarged sectional view of the keyboard unit depicted in FIG. 1 in which a keyboard lid has been opened to expose a keyboard section upward;

FIG. 3 is an exploded perspective view of the keyboard unit depicted in FIG. 2, in which the main section of the keyboard unit has been disassembled;

FIG. 4 is a perspective view of a keyboard musical instrument in which a first main body case has been mounted on the keyboard unit depicted in FIG. 3;

FIG. 5 is an enlarged sectional view of the keyboard musical instrument depicted in FIG. 4;

FIG. 6 is a perspective view of a keyboard musical instrument in which a second main body case has been mounted on the keyboard unit depicted in FIG. 3;

FIG. 7 is an enlarged sectional view of the keyboard musical instrument depicted in FIG. 6;

FIG. 8 is a perspective view of a keyboard musical instrument in which a third main body case has been mounted on the keyboard unit depicted in FIG. 3; and

FIG. 9 is an enlarged sectional view of the keyboard musical instrument depicted in FIG. 8.

### DETAILED DESCRIPTION OF THE PREFERRED EMBODIMENTS

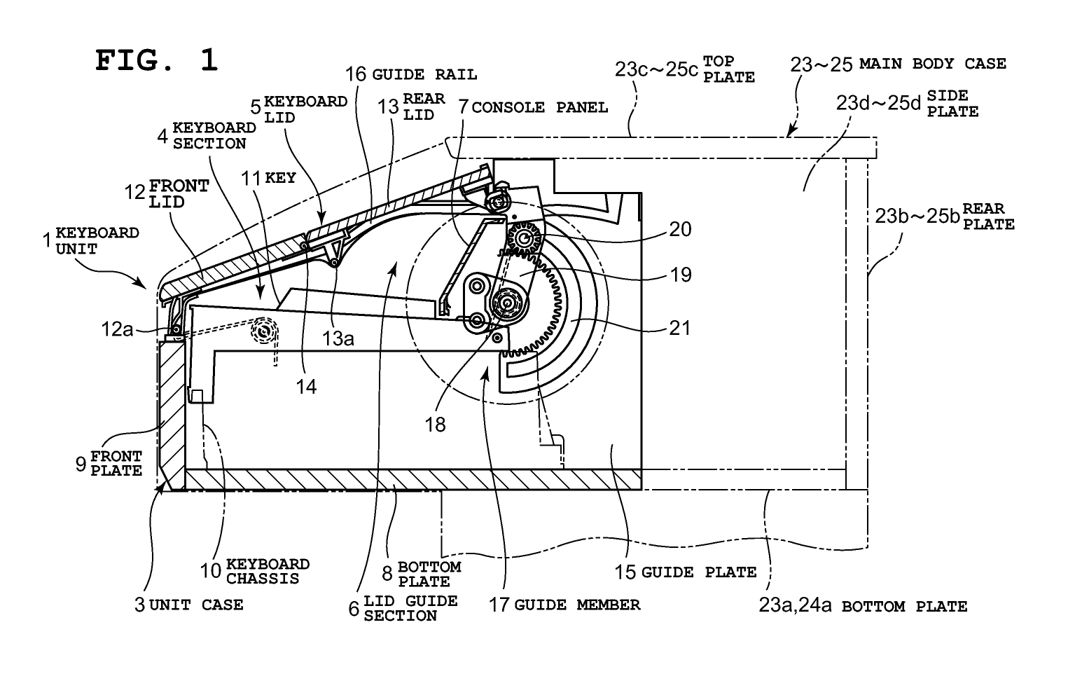

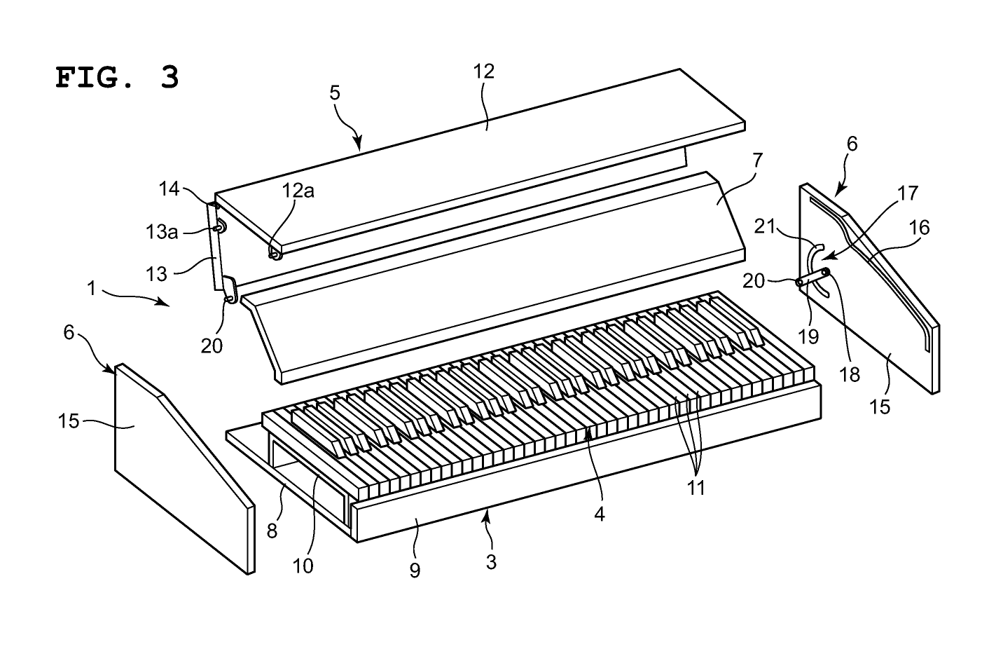

An embodiment in which the present invention has been applied to a keyboard musical instrument is described hereafter with reference to FIG. 1 to FIG. 9.

This keyboard musical instrument includes a keyboard unit 1, as depicted in FIG. 1 to FIG. 3. The keyboard unit 1 is manufactured with a unit case 3, a keyboard section 4, a keyboard lid 5, a lid guide section 6, and a console panel 7 integrated together. The unit case 3 has a bottom plate 8 and a front plate 9 provided upright on the front portion of the bottom plate 8.

As depicted in FIG. 1 to FIG. 3, the keyboard section 4 is structured to have a keyboard chassis 10 placed on the bottom plate 8 of the unit case 3 and a plurality of keys 11 parallelly arranged on the keyboard chassis 10 which are rotatable in a vertical direction. These keys 11 are placed on the unit case 3 with each front end thereof being close to the front plate 9 and slightly projecting upward.

As depicted in FIG. 1 to FIG. 3, the console panel 7 is placed diagonally rearward and upward from above the rear portion of the keyboard section 4. The keyboard lid 5 is structured to openably and closably cover the keyboard section 4 and the console panel 7. That is, the keyboard lid 5 is structured to have a front lid 12 and a rear lid 13 so as to be foldable at a hinge 14 which couples the front lid 12 and the rear lid 13 together.

As depicted in FIG. 1 to FIG. 3, the lid guide section 6 is mounted on each side of the unit case 3, and guides the keyboard lid 5 so that the keyboard lid 5 is freely opened and closed. This lid guide section 6 is structured to place the front lid. 12 and the rear lid 13 substantially in a flat plate shape when the keyboard lid 5 is closed and cover the upper side of the keyboard section 4, and to place the rear lid 13 close to the rear portion of the keyboard section 4 so that it is covered, by bending the front lid 12 and the rear lid 13 at the hinge 14 when the keyboard lid 5 is opened to expose the keyboard section 4 upward. That is the lid guide section 6 is structured such that a guide rail 16 and a guide member 17 are provided on each of paired guide plates 15.

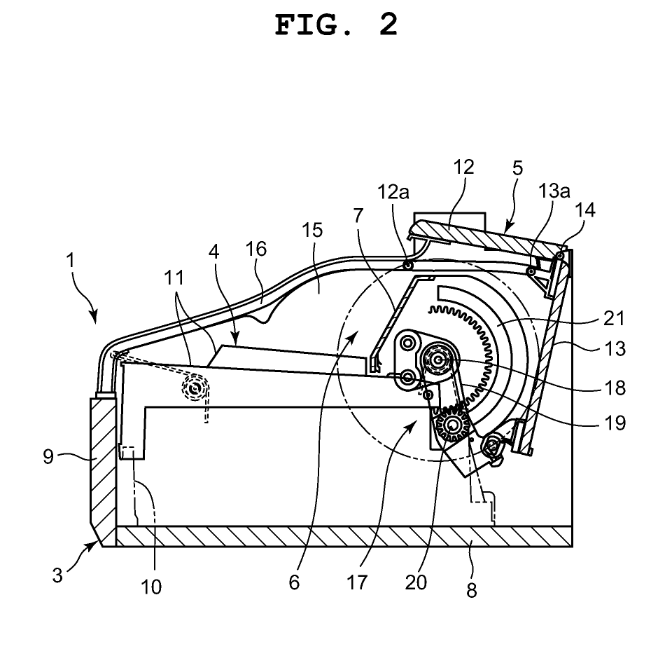

As depicted in FIG. 1 and FIG. 2, the guide rail 16 is provided obliquely on the inner surface of each of the paired guide plates 15, and guides a guide shaft 12a provided at the front end of the front lid 12 and a guide shaft 13a provided at the front end of the rear lid 13. That is, each guide rail 16 is provided obliquely on the inner surface of the guide plate 15 from above the front end of the keyboard section 4 to an area behind the console panel 7 positioned above the rear portion of the keyboard section 4, via an area above the console panel 7.

As depicted in FIG. 1 to FIG. 3, the guide member 17 includes a support shaft 18 provided on the inner surface of the guide plate 15 in an area near the upper portion of the rear end of the keyboard section 4, an arm section 19 rotatably mounted on the support shaft 18, a coupling shaft 20 coupling a tip of the arm section 19 and the rear end of the rear lid 13 together, and a guide groove section 21 provided on the guide plate 15 to form an arc shape centering on the support shaft 18 so as to guide the coupling shaft 20.

As a result, as depicted in FIG. 1, the lid guide section 6 is structured so that the guide shaft 12a of the front lid 12 is positioned at the front end of the guide rail 16, the guide shaft 13a of the rear lid 13 is positioned at an intermediate portion of the guide rail 16, and the coupling shaft 20 behind an edge of the rear lid 13 is positioned at the upper end of the guide groove section 21 when the front lid 12 and the rear lid 13 of the keyboard lid 5 are closed and cover the upper side of the keyboard section 4, whereby the front lid 12 and the rear lid 13 are placed to become a flat plate shape in a state of being tilted forward and downward.

As depicted in FIG. 2, the lid guide section 6 is structured so that the keyboard lid 5 is bent at the hinge 14 coupling the front lid 12 and the rear lid 13 together, the guide shaft 12a of the front lid 12 is positioned in the guide rail 16 above the rear portion of the keyboard section 4, the guide shaft 13a of the rear lid 13 is positioned at the rear end of the guide rail 16, and the coupling shaft 20 behind an edge of the rear lid 13 is positioned at the rear end of the guide groove section 21 when the front lid 12 and the rear lid 13 of the keyboard lid 5 are opened to expose the keyboard section 4 upward. When the front lid 12 and the rear lid 13 are opened, the rear lid 13 is placed drooping downward by being bent with respect to the front lid 12 and approaching the rear portion of the keyboard section 4 so as to cover the rear portion of the keyboard section 4. As a result, the rear lid 13 of the keyboard lid 5 is accommodated in a space behind the keyboard section 4, in the unit case 3. Thus, a structure is achieved that avoids the lids from being positioned in an acoustic space of the loudspeaker at the time of opening the lids, thereby sufficiently attaining the performance of the acoustic space.

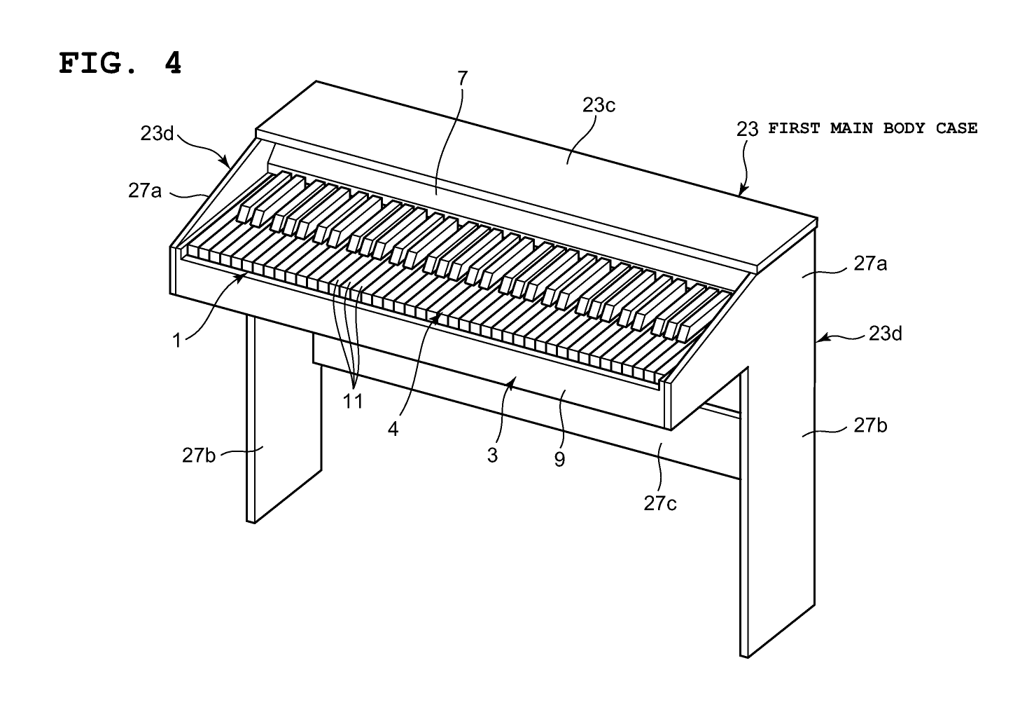

As depicted in FIG. 4 to FIG. 9, the keyboard unit 1 is structured to have any one of main body cases 23 to 25 having different sizes and shapes for each model. The plurality of main body cases 23 to 25 include bottom plates 23a and 24a, rear plates 23b to 25b, top plates 23c to 25c, and paired side plates 23d to 25d, respectively. The bottom plates 23a and 24a, the rear plates 23b to 25b, the top plates 23c to 25c, and the paired side plates 23d to 25d are different in size and shape for each model.

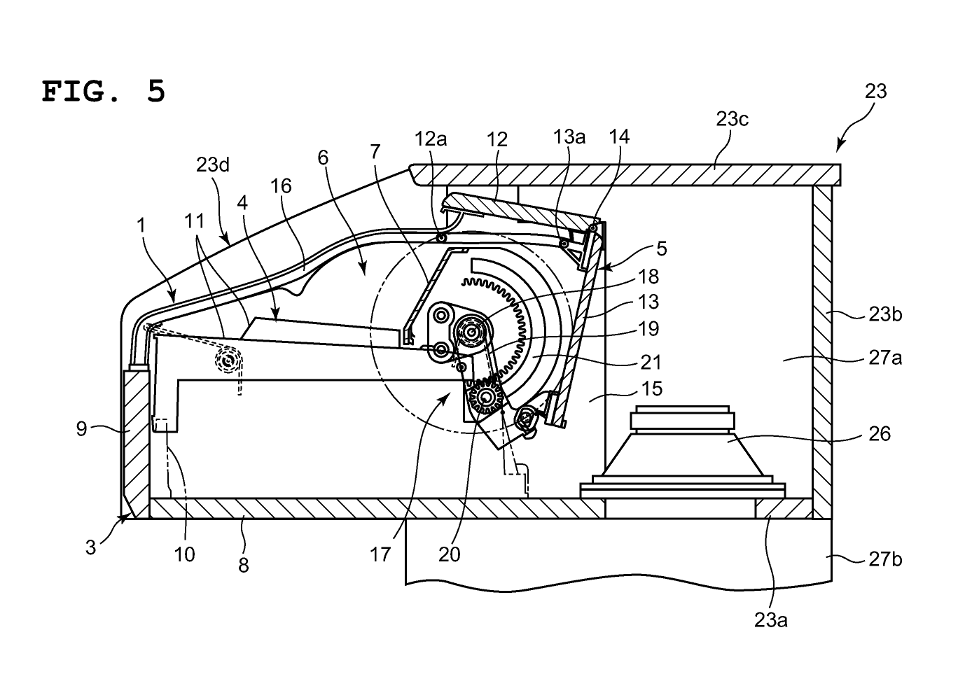

That is, among the plurality of main body cases 23 to 25, the first main body case 23 is structured to have leg portions on both left and right sides and to have a loudspeaker 26 placed downward therein, as depicted in FIG. 4 and FIG. 5. In this case, the bottom plate 23a is formed such that the length in the front to rear direction is substantially equal to the outer diameter of the loudspeaker 26, and mounted on the rear end face of the bottom plate 8 of the keyboard unit 1 by a coupling member (not shown) such as a dowel.

As depicted in FIG. 5, the rear plate 23b of the first main body case 23 is formed slightly higher than the height of the keyboard unit I from the bottom plate 8 to an upper surface of the keyboard lid 5, and provided upright on the rear end of the bottom plate 23a. The top plate 23c is formed such that the length in the front to rear direction is equal to the length from the upper portion of the rear plate 23b to an area above the console panel 7 of the keyboard unit 1.

As depicted in FIG. 4, the paired side plates 23d are vertically elongated flat plates serving also as leg portions, and each of which includes a side plate portion 27a and a leg portion 27b. In this case, as depicted in FIG. 5, the side plate portion 27a is placed across the unit case 3 and the main body case 23, and has the lid guide section 6 of the keyboard unit 1 mounted on the inner surface thereof.

That is, as depicted in FIG. 4 and FIG. 5, the length of the side plate portion 27a in the front to rear direction is equal to a length from the front plate 9 of the unit case 3 to the rear plate 23b of the main body case 23 and the height thereof is equal to a height from the bottom plate 8 and the bottom plate 23a on the rear side to the top plate 23c. The leg portion 27b of the side plate 23d is formed to be elongated in the vertical direction and the length thereof in the front to rear direction is substantially equal to the length of the top plate 23c in the front to rear direction. In this case, as depicted in FIG. 4, a reinforcing plate 27c is provided between rear portions of the paired leg portions 27b.

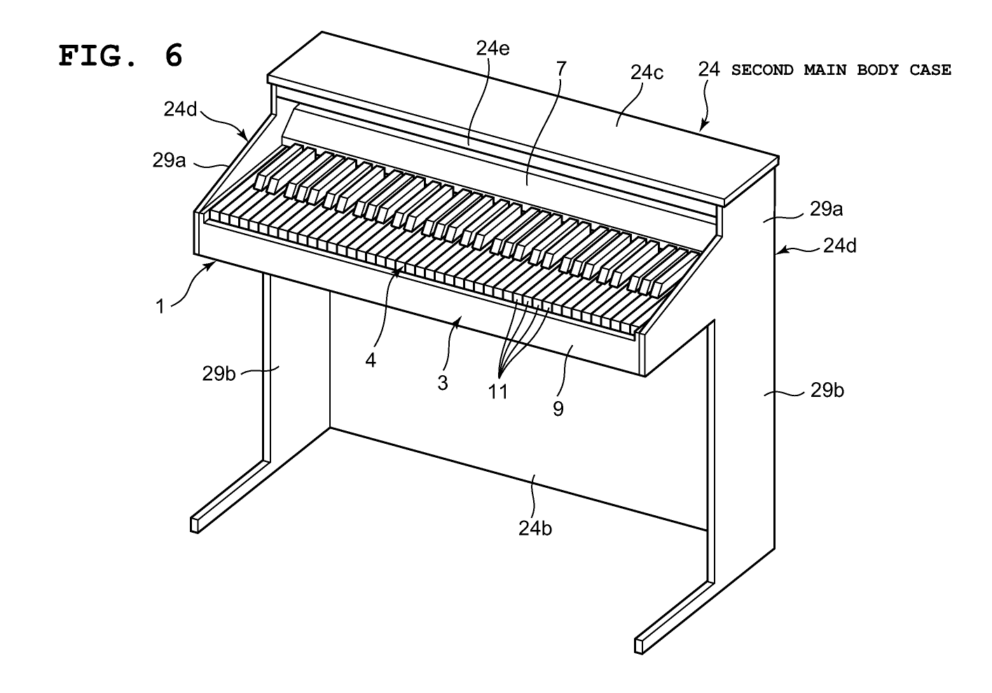

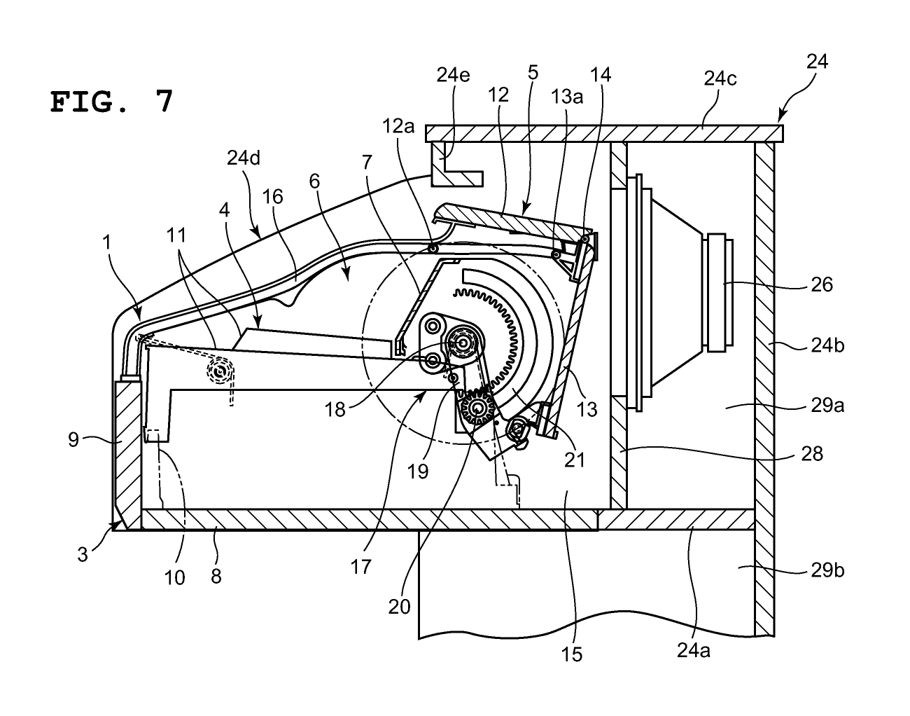

Among the plurality of main body cases 23 to 25, the second main body case 24 is made of luxury wood and is structured to have leg portions on both left and right sides and at the rear portion, and the loudspeaker 26 placed therein so as to be oriented forward, as depicted in FIG. 6 and FIG. 7. In this case, the bottom plate 24a is formed such that the length thereof in the front to rear direction is substantially equal to the thickness of the loudspeaker 26, and mounted on the rear end face of the bottom plate 8 of the keyboard unit 1 by a coupling member (not shown) such as a dowel. In addition, a mount plate 28 for mounting the loudspeaker 26 is provided upright near a boundary between the bottom plate 24a and the bottom plate 8 of the keyboard unit 1.

As depicted in FIG. 6 and FIG. 7, the rear plate 24b of the second main body case 24 serves as a leg portion on the rear side and is provided at the rear end of the bottom plate 24a along the vertical direction. That is, the rear plate 24b is formed such that the height on the upper side of the bottom plate 24a is slightly higher than the outer diameter of the loudspeaker 26 and higher than the height of the keyboard unit 1 from the bottom plate 8 to the upper surface of the keyboard lid 5, and the height on the lower side of the bottom plate 24a is sufficiently long to form a leg portion.

As depicted in FIG. 7, the length of the top plate 24 in the front to rear direction is equal to a length from the upper portion of the rear plate 24b to an area above the console panel 7 of the keyboard unit 1. On the front end of the top plate 24c, a front cover portion 24e is provided. As depicted in FIG. 6, the paired side plates 24d are vertically elongated flat plates serving also as leg portions, and each of which includes a side plate portion 29a and a leg portion 29b. In this case, the side plate portion 29a is placed across the unit case 3 and the second main body case 24, and the lid guide section 6 of the keyboard unit 1 is mounted on the inner surface thereof.

That is, as depicted in FIG. 7, the length of the side plate portion 29a in the front to rear direction is equal to a length from the front plate 9 of the unit case 3 to the rear plate 24h of the second main body case 24 and the height thereof is equal to a height from the bottom plate 8 and the bottom plate 24a on the rear side to the top plate 24c. As depicted in FIG. 6, the leg portion 29h of the side plate 24d is formed to be elongated in the vertical direction and the length thereof in the front to rear direction is substantially equal to the length of the top plate 24c in the front to rear direction. The leg portion 29b has a lower end extending to an area corresponding to the front plate 9 of the unit case 3.

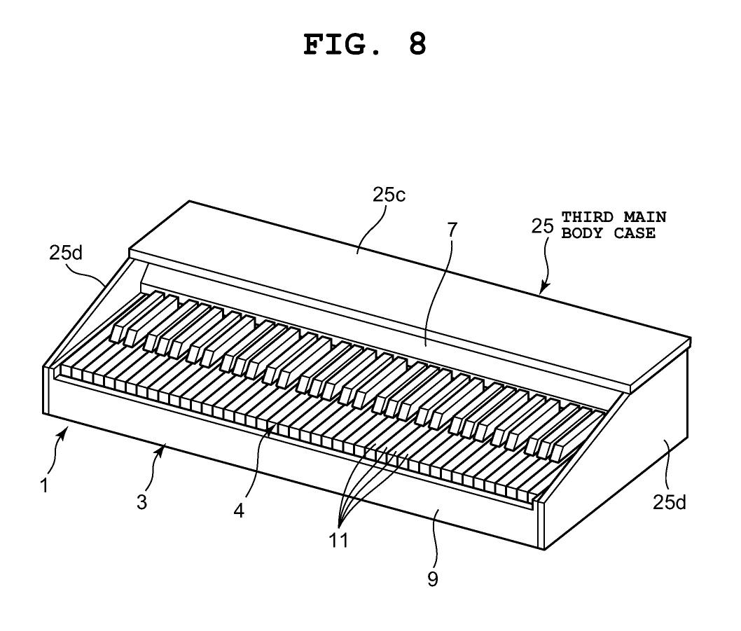

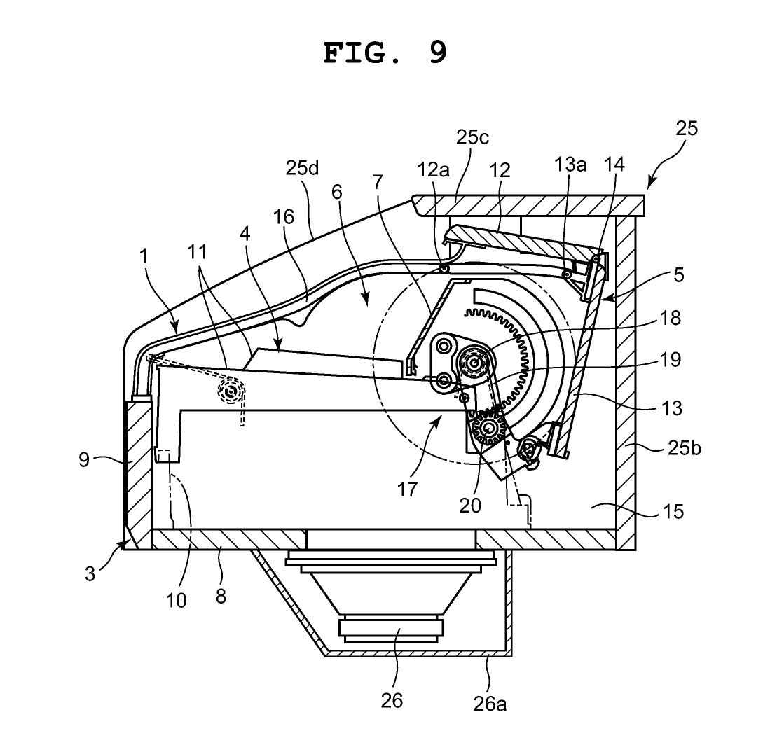

Furthermore, among the plurality of main body cases 23 to 25, the third main body case 25 is structured such that the loudspeaker 26 is placed upward on the lower surface of the unit case 3, as depicted in FIG. 8 and FIG. 9. In this case, the loudspeaker 26 is covered with a loudspeaker box 26a provided on the lower surface of the unit case 3. This third main body case 25 is structured such that the rear plate 25b is provided upright at the rear end of the bottom plate 8 of the unit case 3 by a coupling member (not shown) such as a dowel.

As depicted in FIG. 9, the rear plate 25b is formed to have a height substantially equal to a height from the bottom plate 8 of the keyboard unit 1 to the upper surface of the keyboard lid 5. The length of the top plate 25c in the front to rear direction is equal to a length from the upper portion of the rear plate 25b to an area above the console panel 7 of the keyboard unit 1.

As depicted in FIG. 9, the paired side plates 25d are placed to cover both of the unit case 3 and the third main body case 25, and are each structured such that the lid guide section 6 of the keyboard unit 1 can be mounted on the inner surface of the side plate 25d. That is, the length of each of the paired side plates 25d in the front to rear direction is equal to a length from the front plate 9 of the unit case 3 to the rear plate 25b of the main body case 25 and the height thereof is equal to a height from the bottom plate 8 and the bottom, plate 23a on the rear side to the top plate 25c.

Next, the operation of the keyboard musical instrument is described.

First, basic components constituting the keyboard musical instrument, that is, the unit case 3, the keyboard section 4, the keyboard lid 5, the lid guide section 6, and the console panel 7 are unitized to constitute the keyboard unit 1, in this case, the unit case 3 is structured by mounting the front plate 9 upright on the front end of the bottom plate 8.

The keyboard section 4 is structured by parallelly arranging the plurality of keys 11 on the keyboard chassis 10 in a manner to be rotatable in the vertical direction. The keyboard chassis 10 of the keyboard section 4 is placed on the bottom plate 8 of the unit case 3. The keyboard lid 5 is structured to have the front lid 12 and the rear lid 13 so as to be foldable at the hinge 14 which couples the front lid 12 and the rear lid 13 together. Also, the paired lid guide sections 6 are placed on the bottom plate 8 of the unit case 3 positioned on both sides of the keyboard section 4.

Then, the console panel 7 is placed corresponding to the upper side of the rear portion of the keyboard section 4 between the paired lid guide sections 6. In this state, the keyboard lid 5 is movably mounted between the paired lid guide sections 6. Here, the guide shaft 12a of the front lid 12 and the guide shaft 13a of the rear lid 13 are movably placed in the guide rails 16 of the lid guide sections 6, and the rear end of the rear lid 13 is coupled to each guide member 17.

In this case, in advance the support shaft 18 of the guide member 17 is mounted on the guide plate 15 of each lid guide section 6 in an area above the rear end of the keyboard section 4, and the arm section 19 is rotatably mounted on the support shaft 18. In addition, the guide groove section 21 of the guide member 17 is provided to the guide plate 15 of each lid guide section 6 in an area behind the keyboard section 4. In this state, the rear end of the rear lid 13 of the keyboard lid 5 and the tip of each arm section 19 are coupled together by each coupling shaft 20 guided by the guide groove section 21 of the guide member 17. As a result, the keyboard unit 1 is assembled.

In the keyboard unit 1 described above, the guide rail 16 of each lid guide section 6 guides the guide shaft 12a of the front lid 12 and the guide shaft 13a of the rear lid 13 when the front lid 12 and the rear lid 13 of the keyboard lid 5 are closed and cover the upper side of the keyboard section 4. With this the guide shaft 12a of the front lid 12 is placed at the front end of the guide rail 16, the guide shaft 13a of the rear lid 13 is placed at the intermediate portion of the guide rail 16, and the coupling shaft 20 behind the rear end of the rear lid 13 is placed at the upper end of the guide groove section 21 with the rotation of the arm section 19 of the guide member 17, whereby the front lid 12 and the rear lid 13 are placed to become a flat plate shape in a state of being tilted forward and downward.

Also, in the keyboard unit 1, the front lid 12 and the rear lid 13 are guided by the guide rail 16 of each lid guide section 6 to be bent at the hinge 14 when the front lid 12 and the rear lid 13 of the keyboard lid 5 are opened to expose the keyboard section 4 upward. With this, the guide shaft 12a of the front lid 12 is positioned in the guide rail 16 above the rear portion of the keyboard section 4, the guide shaft 13a of the rear lid 13 is positioned at the rear end of the guide rail 16, and the coupling shaft 20 near the rear end of the rear lid 13 is positioned at the rear end of the guide groove section 21 according to the rotation of the arm section 19 of the guide member 17. As a result, by being bent to cover the rear portion of the keyboard section 4, the rear lid 13 is placed drooping downward near the rear portion of the keyboard section 4.

Then, any one of the plurality of main body cases 23 to 25 is mounted on the keyboard unit 1 to constitute a keyboard musical instrument. In this case, for example, before the first main body case 23 is mounted on the keyboard unit 1 among the plurality of main body cases 23 to 25, the rear plate 23b is mounted upright on the rear end of the bottom plate 23a, and the loudspeaker 26 is mounted on the bottom plate 23a so as to be oriented downward, as depicted in FIG. 4 and FIG. 5,

In this state, the paired side plates 23d are mounted on both side portions of the first main body case 23. Here, the side plate portion 27a of each of the paired side plates 23d is mounted on the bottom plate 23a and the rear plate 23b of the first main body case 23. With this, the bottom plate 23a and the rear plate 23b of the first main body case 23 are supported by the respective leg portions 27b positioned on the lower side of the paired side plates 23d.

Then, the unit case 3 of the keyboard unit 1 is mounted on the first main body case 23. Here, the guide plate 15 of each lid guide section 6 of the keyboard unit I is first mounted on the inner surface of each side plate portion 27a of the paired side plates 23d. In this state, the front end of the bottom plate 23a of the first main body case 23 is mounted on the rear end of the bottom plate 8 of the unit case 3 with a coupling member (not shown) such as a dowel. In addition, the paired side plates 23d are mounted on both sides of the unit case 3.

Then, the paired side plates 23d are mounted such that the side plate portions 27a of the upper portions thereof are placed across the unit case 3 and the first main body case 23, and the unit case 3 and the first main body case 23 are supported by the leg portions 27b positioned on the lower sides of the paired side plates 23d. Then, the top plate 23c is mounted on the upper portions of the paired side plates 23d and the upper portion of the rear plate 23b.

As a result, the keyboard musical instrument is assembled with the keyboard section 4 exposed upward. In the keyboard musical instrument structured as described above, when the plurality of keys 11 of the keyboard section 4 are pressed to play music with the keyboard lid 5 being opened to expose the keyboard section 4, musical sound according to the play is emitted from the loudspeaker 26. Here, since the loudspeaker 26 has been placed in the first main body case 23 so as to be oriented downward, a high-pitched sound is emitted downward, and a low-pitched sound is emitted from the first main body case 23 side and the keyboard section 4 side.

In this case, the inside of the first main body case 23 is partitioned by the keyboard lid 5 with respect to the unit case 3, forming an acoustic space of the loudspeaker 26. That is, when the keyboard lid 5 is opened to expose the keyboard section 4, the keyboard lid 5 is bent at the boundary between the front lid 12 and the rear lid 13 to cover the rear portion of the keyboard section 4, whereby the first main body case 23 and the unit case 3 are substantially partitioned by the bent keyboard lid 5 including the front lid 12 and the rear lid 13. Accordingly, a high-pitch sound from the loudspeaker 26 is emitted from the lower side of the first main body case 23, and a low-pitched sound is emitted forward from the upper side of the first main body case 23 and the keyboard section 4 side.

For example, before the second main body case 24 among the plurality of main body cases 23 to 25 is mounted on the keyboard unit 1 as depicted in FIG. 6 and FIG. 7, the mount plate 28 is mounted upright on the front end of the bottom plate 24a, and the loudspeaker 26 is mounted on the mount plate 28 so as to be oriented forward. In this state, the paired side plates 24d are mounted on both sides of the second main body case 24, and the rear plate 24b is mounted on the rear portion of the second main body case 24.

Here., each side plate portion 29a of the paired side plates 24d is mounted on the bottom plate 24a of the second main body case 24. With this, the bottom plates 24a of the second main body case 24 is supported by the leg portions 29b positioned on the lower sides of the paired side plates 24d. Also, the upper side of the rear plate 24b is mounted on the rear end of the bottom plate 24a of the second main body case 24. With this, the lower side of the rear plate 24b serves as a leg portion, and both sides of this leg portion are mounted on the leg portions 29b of the paired side plate 24d. With this, the bottom plate 24a of the second main body case 24 is supported by each leg portion 29b of the paired side plates 24d and the leg portion of the rear plate 24b.

In this state, the unit case 3 of the keyboard unit 1 is mounted on the second main body case 24. Here, the guide plate 15 of the lid guide section 6 of the keyboard unit 1 is first mounted on the inner surface of each side plate 29a of the paired side plates 24d. Then, the front end of the bottom plate 24a is mounted on the rear end of the bottom plate 8 of the unit case 3 by a coupling member (not shown) such as a dowel, and each side plate portion 29a of the paired side plates 24d is mounted on the bottom plate 8 of the unit case 3.

With this, the side plate portions 29a of the paired side plates 24d are mounted across the unit case 3 and the second main body case 34, and the unit case 3 and the second main body case 24 are supported by each leg portion 29b of the paired side plates 24d and the leg portion of the rear plate 24b. Then, the top plate 24c is mounted on the upper portions of the paired side plates 24d and the upper portion of the rear plate 24b.

As a result, the keyboard musical instrument is assembled with the keyboard section 4 being exposable upward. In the keyboard musical instrument structured as described above, when the plurality of keys 11 of the keyboard section 4 are pressed to play music with the keyboard lid 5 being opened to expose the keyboard section 4 upward, musical sound according to the play is emitted from the loudspeaker 26. Here, since the loudspeaker 26 has been placed in the second main body case 24 so as to be oriented forward, a high-pitched sound is emitted forward from the keyboard section 4 side, and a low-pitched sound is emitted from the second main body case 24.

In this case, the inside of the second main body case 24 has been partitioned by the mount plate 28 with respect to the unit case 3, forming an acoustic space of the loudspeaker 26. Also, since the keyboard lid 5 has been opened to expose the keyboard section 4, musical sound is emitted forward from gaps between the plurality of keys 11 of the keyboard section 4. Thus, a high-pitched sound from the loudspeaker 26 is emitted forward from the gaps between the plurality of keys 11 of the keyboard section 4, and a low-pitched sound is emitted from the upper, lower, and rear sides of the second main body case 24.

Furthermore, for example, when the third main body case 25 among the plurality of main body cases 23 to 25 is mounted on the keyboard unit 1 as depicted in FIG. 8 and FIG. 9, the rear plate 25b of the second main body case 25 is first mounted on the rear end of the bottom plate 8 of the unit case 3 by a coupling member (not shown) such as a dowel. In this state, the paired side plates 25d are mounted on both sides of the unit case 3 and the third main body case 25. Here, the guide plate 15 of the lid guide section 6 of the keyboard unit 1 is first mounted on the inner surface of each the paired side plates 25d.

Then, the paired side plates 25d are mounted on both of the bottom plate 8 of the unit case 3 and the rear plate 25b of the third main body case 25. With this, the paired side plates 25d are mounted across the unit case 3 and the third main body case 25. Then, the top plate 25c is mounted on the upper portions of the paired side plates 25d and the upper portion of the rear plate 25b. In this state, the loudspeaker 26 is mounted on the lower surface of the bottom plate 3 of the unit case 3 so as to be oriented upward.

As a result, the keyboard musical instrument is assembled with the keyboard section 4 being exposable upward. In the keyboard musical instrument structured as described above, when the plurality of keys 11 of the keyboard section 4 are pressed to play music with the keyboard lid 5 being opened to expose the keyboard section 4, musical sound according to the play is emitted from the loudspeaker 26. Here, since the loudspeaker 26 has been placed on the unit case 3 so as to be oriented upward, a high-pitched sound is emitted forward from the keyboard section 4 side, and a low-pitched sound is emitted downward from the unit case 3.

As such, the keyboard unit 1 of the keyboard musical instrument includes the unit case 3 having the bottom plate 8 and the front plate 9, the keyboard section 4 placed on the bottom plate 8 of the unit case 3, the keyboard lid 5 which operably and closably covers the keyboard section 4, the keyboard lid 5 that is foldable at the hinge 14 between the front lid 12 and the rear lid 13, and the lid guide section 6 which guides the keyboard lid 5 so that the keyboard lid 5 is freely opened and closed, places the front lid 12 and the rear lid 13 in a substantially flat plate shape when the keyboard lid 5 covers the upper side of the keyboard section 4, and bends the front lid 12 and the rear lid 13 so that they cover the rear portion of the keyboard section 4 when the keyboard lid 5 is opened to expose the keyboard section 4 upward. This allows commonality of the basic components constituting the keyboard musical instrument and improves productivity.

That is, in the keyboard unit 1, the unit case 3, the keyboard section 4, the keyboard lid 5, and the lid guide section 6 are unitized, whereby commonality of the basic components constituting the keyboard musical instrument is achieved. Also, when the keyboard lid 5 is opened using the lid guide section 6, the rear portion of the keyboard section 4 can be covered by the keyboard lid 5 for partitioning. Therefore, even if the size and shape of the musical instrument case differ according to the position where an accessory component such as the loudspeaker 26 is to be placed, a musical instrument can he easily manufactured only by additionally providing a portion different for each model. This can improve productivity and decrease cost.

In the keyboard unit 1, by unitizing not only the unit case 3, the keyboard section 4, the keyboard lid 5, and the lid guide section 6 but also the console panel 7, commonality of more components can be achieved, which simplifies musical instrument manufacture. Therefore, productivity can be further improved, and also cost can be reduced.

When the keyboard lid 5 is guided by the lid guide section 6 to open the keyboard section 4 upward, the front lid 12 and the rear lid 13 are bent at the hinge 14. By the rear lid 13 of the folded keyboard lid 5 being placed to droop near the rear portion of the keyboard section 4, the rear portion of the keyboard section 4 can be favorably and reliably covered, and the keyboard unit 1 can be made compact as a whole. Accordingly, even when any one of the plurality of main body cases 23 to 25 having different sizes and shapes for each model is additionally provided, the additionally provided main body cases 23, 24 or 25 and the unit case 3 can be favorably partitioned.

As such, the keyboard musical instrument includes the keyboard unit 1 described above and is structured such that one of the plurality of main body cases 23 to 25 having different sizes and shapes for each model is mounted on the unit case 3 of the keyboard unit 1. Therefore, only by mounting any one of the plurality of main body cases 23 to 25 that are different for each model, a desired musical instrument can be easily manufactured, which improves productivity and reduces cost

That is, in the keyboard musical instrument, the plurality of main body cases 23 to 25 include the bottom plates 23a and 24a, the rear plates 23b to 25b the top plates 23c to 25c, and the paired side plates 23d to 25d, respectively, which are different in size and shape for each model. Therefore, an accessory component such as the loudspeaker 26 can be installed at an optimum position according to the situation.

In this case, in the first main body case 23 of the plurality of main body cases 23 to 25, the loudspeaker 26 can be placed to be oriented downward. In the second main body case 24, the loudspeaker 26 can be placed to be oriented forward, in the third main body case 25, the loudspeaker 26 can be placed on the lower surface of the unit case 3 to be oriented upward,

Also, each of the plurality of main body cases 23 to 25 and both sides of the unit case 3 are provided with the paired side plates 23d, 24d or 25d placed across them. Therefore, although the sizes and shapes of the musical instrument cases vary for each model, each of the plurality of main body cases 23 to 25 and the unit case 3 can be strongly coupled to be mounted, by using the paired side plates 23d, 24d or 25d. As a result, a musical instrument case according to the use purpose can be provided.

In this case, among the paired side plates 23d to 25d in the first to third main body cases 23 to 25, for example, the paired side plates 23d and 24d of the first and second main body cases 23 and 24 have the leg portions 27b and 29b, respectively. Therefore, by the leg portions 27b and 29b of the paired side plates 23d and 24d, the unit case 3 and the first and second main body cases 23 and 24 can be favorably and reliably supported at a predetermined height.

Also, since the lid guide section 6 has been provided on the inner surface of each of the paired side plates 23d to 25d in the first to third main body cases 23 to 25, the lid guide section 6 can be reliably and strongly fixed, whereby the keyboard lid can be reliably and stably held inside the unit case, and the keyboard lid 5 can be smoothly and favorably opened and closed. Accordingly, a product with a preferable outer appearance and design can be obtained.

Moreover, by the loudspeaker 26 being placed at a different position for each model in each of the first and second main body cases 23 and 24, the loudspeaker 26 can be installed at an optimum position regardless of the model. For example, in the first main body case 23 among the first and second main body cases 23 and 24, the loudspeaker 26 can be placed to be oriented downward. In the second main body case 24, the loudspeaker 26 can be placed to be oriented forward.

Furthermore, by the loudspeaker 26 being placed on the lower surface of either one of the unit case 3 and the third main body case 25, the third main body case 25 can be structured to be compact, and the structure of which can be simplified. Accordingly, a musical instrument can be easily manufactured, whereby productivity can be improved and cost can be reduced.

In the above-described embodiments, the loudspeaker 26 is provided inside the first or second main body cases 23 or 24 and the lower surface of the unit case 3. However, the present invention is not limited thereto and the loudspeaker 26 may be provided on the lower surface of the first or second main body cases 23 or 24, or provided across the first or second main body case 23 or 24 and the unit case 3.

Also, in the above-described embodiments, the loudspeaker 26 is provided to a keyboard musical instrument as an accessory component. However, the loudspeaker 26 is not necessarily required to be provided, and a structure may be adopted in which a keyboard musical instrument is electrically connected to an external device such as a synthesizer and then connected to a loudspeaker of the external device. Also, the accessory component is not necessarily required to be the loudspeaker 26, and may be a board box having a circuit board incorporated therein.

Moreover, in the above-described embodiments, the keyboard lid 5 has the front lid 12 and the rear lid 13 coupled together with, the hinge 14. However, the present invention is not limited thereto. For example, the keyboard lid 5 may be divided into three or more lid sections, and the divided lid sections may be sequentially coupled together each with a foldable coupling member such as the hinge 14.

Furthermore, in the above-described embodiments, the lid guide section 6 is mounted on the sides of the unit case 3. However, the lid guide section 6 may be structured to be mounted on the chassis.

Still further, in the above-described embodiments, the console panel 7 is integrally formed with the keyboard unit 1. However, the console panel 7 may be changed depending on the model, and therefore is not necessarily required to be integrally formed.

While the present invention has been described with reference to the preferred embodiments, it is intended that the invention be not limited by any of the details of the description therein but includes all the embodiments which fall within the scope of the appended claims.

What is claimed is:

1. A keyboard unit comprising;
a unit case which has a bottom plate;
a keyboard chassis;
a keyboard section which has a plurality of keys arranged in parallel to each other; and
a lid guide section which guides a keyboard lid having a plurality of lid sections which are foldable and coupled together,
wherein the lid guide section guides the keyboard lid such that folding of the keyboard lid is released when the keyboard lid covers upper side of the keyboard section, and guides the keyboard lid by folding the keyboard lid such that at least part of the plurality of lid sections is directed toward a direction of rear portion of the keyboard section and the bottom plate and thereby accommodated in the unit case behind the keyboard section when the keyboard lid exposes the upper side of the keyboard section.

2. The keyboard unit according to claim 1, wherein the keyboard lid is placed with the plurality of lid sections being bent and positioned near the rear portion of the keyboard section when the keyboard lid is guided by the lid guide section to expose the upper side of the keyboard section.

3. A keyboard musical instrument comprising the keyboard unit according to claim 1, wherein any one of a plurality of main body cases having different sizes and shapes for each model is mounted on the unit case of the keyboard unit.

4. The keyboard musical instrument according to claim 3, wherein the plurality of main body cases each include a rear plate, side plates, and a top plate which are different in size and shape for each model.

5. The keyboard musical instrument according to claim 3, wherein the side plates are provided across side portions of the unit case and side portions of the main body case.

6. The keyboard musical instrument according to claim 5, wherein the lid guide section is provided on inner surface of each of the side plates.

7. The keyboard musical instrument according to claim 3, wherein the plurality of main body cases each have a loudspeaker arranged therein, and the keyboard lid is positioned so as to avoid an acoustic space formed by the loudspeaker when the upper side of the keyboard section is exposed.

8. The keyboard musical, instrument according to claim 3, wherein a loudspeaker is arranged on lower surface of at least one of the unit case and the main body cases, and the keyboard lid is positioned so as to avoid an acoustic space formed by the loudspeaker when the upper side of the keyboard section is exposed.
